(19) United States
(12) Patent Application Publication
(10) Pub. No.: US 2013/0071718 A1
(43) Pub. Date: Mar. 21, 2013

(54) HEAT DISSIPATION PLATE FOR BATTERY CELL AND BATTERY MODULE HAVING THE SAME

(71) Applicants: Jeong Min CHO, Uiwang (KR); Gun Goo LEE, Suwon (KR); Na Ry SHIN, Hwaseong (KR); Jin Woo KWAK, Uiwang (KR)

(72) Inventors: Jeong Min CHO, Uiwang (KR); Gun Goo LEE, Suwon (KR); Na Ry SHIN, Hwaseong (KR); Jin Woo KWAK, Uiwang (KR)

(73) Assignee: Hyundai Motor Company, Seoul (KR)

(21) Appl. No.: 13/314,058

(22) Filed: Dec. 7, 2011

(30) Foreign Application Priority Data
Sep. 20, 2011 (KR) 10-2011-0094899

(51) Int. Cl. H01M 10/50; F28F 27/00

(52) U.S. Cl. 429/120; 165/276

(57) ABSTRACT

Disposed is a heat dissipation plate, which is an interface plate interposed between a plurality of battery cells, can respond to changes in volume of the battery cells, and can effectively dissipate heat accumulated in the battery cells, and a battery module having the same. To this end, the heat dissipation plate includes a porous metal foam plate formed by foaming and having a plate shape. A sheet plate is stacked on both sides of the metal foam plate. When the battery cells expand, the metal foam plate is compressed by the expansion of the battery cells, thereby responding to changes in volume of the battery cells and improving heat dissipation performance by air cooling due to increased specific surface area.

### CROSS-REFERENCE TO RELATED APPLICATION

This application claims under 35 U.S.C. §119(a) the benefit of Korean Patent Application No. 10-2011-0094899 filed Sep. 20, 2011, the entire contents of which are incorporated herein by reference.

### BACKGROUND

(a) Technical Field

The present invention relates to a heat dissipation plate for a battery cell and a battery module having the same. More particularly, it relates to a heat dissipation plate, which is an interface plate interposed between battery cells, can respond to changes in volume of the battery cells, and can effectively dissipate heat accumulated in the battery cells, and a battery module having the same.

(b) Background Art

In a typical battery for an electric vehicle, a local temperature difference or increased temperature is caused by heat generated due to high power, high speed, and repeated charging, which causes thermal runaway, thereby reducing the efficiency and reliability of the battery. The thermal runaway is caused by a lack of ability to dissipate and transfer the heat to the outside of the battery rather than by the heat generated inside the battery.

With the development of high-tech products such as digital cameras, cellular phones, notebook computers, electric and hybrid vehicles, etc., extensive research on secondary batteries capable of charging and discharging has continued to progress, unlike primary batteries. Examples of the secondary batteries may include nickel-cadmium batteries, nickel-metal hybrid batteries, nickel-hydrogen batteries, lithium secondary batteries, etc. Among them, the lithium secondary battery has an operating voltage of 3.6 V or higher and is used as a power supply for a portable electronic device. Otherwise, a plurality of lithium secondary batteries are connected in series and used in a high power hybrid vehicle. Such a lithium secondary battery has an operating voltage, which is three times higher than that of the nickel-cadmium battery or nickel-metal hybrid battery, and has a high energy density per unit weight.

A lithium secondary battery can be manufactured in various forms. For example, a pouch-type lithium secondary battery having a free shape has recently been developed. Each of a plurality of battery cells, which constitutes a conventional pouch-type lithium secondary battery, includes a battery portion and a pouch-type case having a space for accommodating the battery portion. The battery portion has a structure in which a positive electrode plate, a separator, and a negative electrode plate are sequentially stacked and wound in one direction or a structure in which a plurality of positive electrode plates, separators, and negative electrode plates are stacked in multiple layers. Moreover, the case has excellent moldability and can be bent freely.

Changes in volume of the pouch-type battery cells are caused by intercalation and deintercalation of lithium ions in electrode materials during charge and discharge (See J. H. Lee et al./Journal of Power Sources 119-121 (2003) 833-837 the contents of which are hereby incorporated by reference).

Due to an increase in volume of the battery cell in the conventional lithium secondary battery, the volume of an air channel (denoted by reference numeral 2 of FIG. 6) formed between the battery cells is reduced to deteriorate the air cooling performance, and the amount of heat generated between adjacent battery cells is increased by an increase in temperature, resulting in a significant deterioration of battery performance.

Moreover, damage to the separator due to expansion of the electrode plates in the battery cell causes an increase in voltage and a reduction in battery capacity as well as an increase in internal resistance. Furthermore, when the volume of the battery cells is significantly increased, the case may be damaged thereby resulting in leakage of internal electrolyte and emission of toxic gases. In addition, a battery module is configured by stacking a plurality of battery cells (or unit cells), and thus in the event of an increase in volume of the battery cells, emission of gas, or explosion, it causes direct damage to adjacent battery cells.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a heat dissipation plate for a battery cell, which is an interface plate interposed between battery cells, can respond to changes in volume of the battery cells, and can effectively dissipate heat accumulated in the battery cells by cooling air. Moreover, the present invention provides a battery module which is configured by interposing the heat dissipation plate between the battery cells to respond to changes in volume of the battery cells and improve heat dissipation performance through air cooling, thereby improving lifespan and reliability of the battery module.

In one aspect, the present invention provides a heat dissipation plate for a battery cell as an interface plate interposed between battery cells, the heat dissipation plate comprising: a porous metal foam plate formed by foaming and having a plate shape; and a sheet plate stacked on both sides of the metal foam plate, wherein when the battery cells expand, the metal foam plate may be compressed by the expansion of the battery cells, thereby responding to changes in volume of the battery cells and improving heat dissipation performance by air cooling due to increased specific surface area.

In the exemplary embodiment, the heat dissipating plate may further comprise a heat dissipation paste applied to the surface of the metal foam plate and interposed between the metal foam plate and the sheet plate. Additionally, the metal foam plate may comprise at least one unidirectional air channel for heat dissipation by air flow.

The metal foam plate and the sheet plate may be made of aluminum, and may extend further from the battery cell to upper and lower sides such that the metal foam plate projects to the outside of the battery cells when interposed between the battery cells.

In some embodiments, the metal foam plate may comprise an electrode folding portion for folding an electrode portion, which is formed to penetrate the lower end of the metal foam plate.

In another aspect, the present invention provides a battery module comprising a plurality of battery cells and a heat dissipation plate interposed between the battery cells, wherein the heat dissipation plate may comprise: a porous metal foam plate formed by foaming and having a plate shape; and a sheet plate stacked on both sides of the metal foam plate, wherein when the battery cells expand, the metal foam plate may be compressed by the expansion of the battery cells, thereby responding to changes in volume of the battery cells and improving heat dissipation performance by air cooling due to increased specific surface area.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic perspective view showing a battery module having a heat dissipation plate in accordance with an exemplary embodiment of the present invention;

FIG. 2 is a front view of FIG. 1;

FIG. 3 is a perspective view showing a heat dissipation plate for a battery cell in accordance with an exemplary embodiment of the present invention;

FIG. 4 is a cross-sectional view taken along line A-A of FIG. 3;

FIG. 5 is a schematic perspective view showing a metal foam plate of a heat dissipation plate in accordance with an exemplary embodiment of the present invention; and

FIG. 6 is a cross-sectional view showing a battery module in accordance with another exemplary embodiment of the present invention and a conventional battery module.

Reference numerals set forth in the Drawings includes reference to the following elements as further discussed below:

10: heat dissipation plate

10a: cell contact portion

10b: upper projection

10c: lower projection

11: metal foam plate

12: heat dissipation paste

13: sheet plate

14: air channel

15: electrode folding portion

20: battery cell

21: electrode portion

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

An increase in a volume of battery cells causes a reduction in battery capacity, and thus to manufacture a compact battery with improved energy density with respect to the volume, both the elasticity and the heat dissipation performance should be high enough to respond to changes in volume of the battery cells. Therefore, the present invention provides a heat dissipation plate which can flexibly respond to changes in volume of battery cells during charge and discharge and can effectively dissipate heat generated from the battery cells by air cooling.

Moreover, the present invention provides a battery module which is configured by interposing the heat dissipation plate between the battery cells and is used as a thermal control component for, e.g., an electrically powered vehicle, thereby improving heat dissipation performance of a high capacity battery for the vehicle and improving lifespan and reliability of the battery module.

The heat dissipation plate for a battery cell in accordance with an exemplary embodiment of the present invention is interposed between the battery cells to respond to changes in volume of the battery cells during charge and discharge, has a high thermal conductivity, and has a macro structure to maximize heat dissipation characteristics by air cooling, and thus the heat dissipation plate is an effective heat dissipation element.

In detail, the heat dissipation plate of the present invention is a porous interface plate made of, e.g., aluminum or any other material having a high thermal conductivity and is interposed between the battery cells to flexibly respond to changes in volume of the battery cells during charge and discharge and to maximize the heat dissipation performance due to the high thermal conductivity.

Referring to FIG. 4, a heat dissipation plate 10 for a battery cell in accordance with an exemplary embodiment of the present invention is an interface plate interposed between the battery cells and made up of a porous metal foam plate 11 formed by foaming and having a plate shape, a sheet plate 13 stacked on both sides of the metal foam plate 11, and a heat dissipation paste 12 interposed between the metal foam plate 11 and the sheet plate 13. The metal foam plate 11 is a porous metal plate made of aluminum having a high thermal conductivity in the form of foam and having desired properties by controlling the size and density of pores to have the required modulus of elasticity and heat dissipation performance.

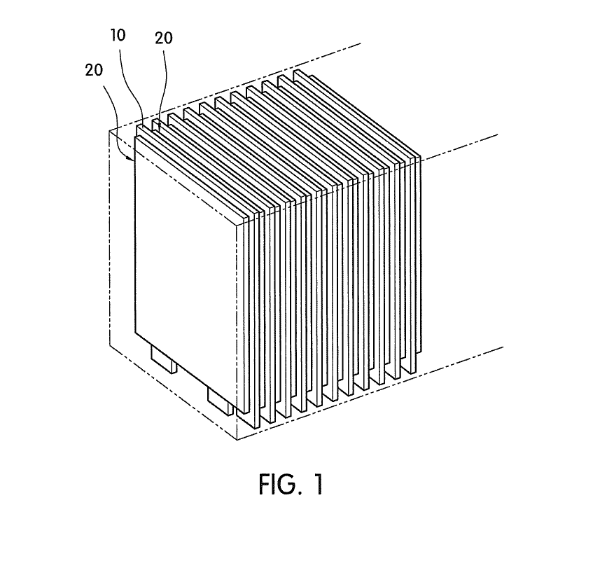

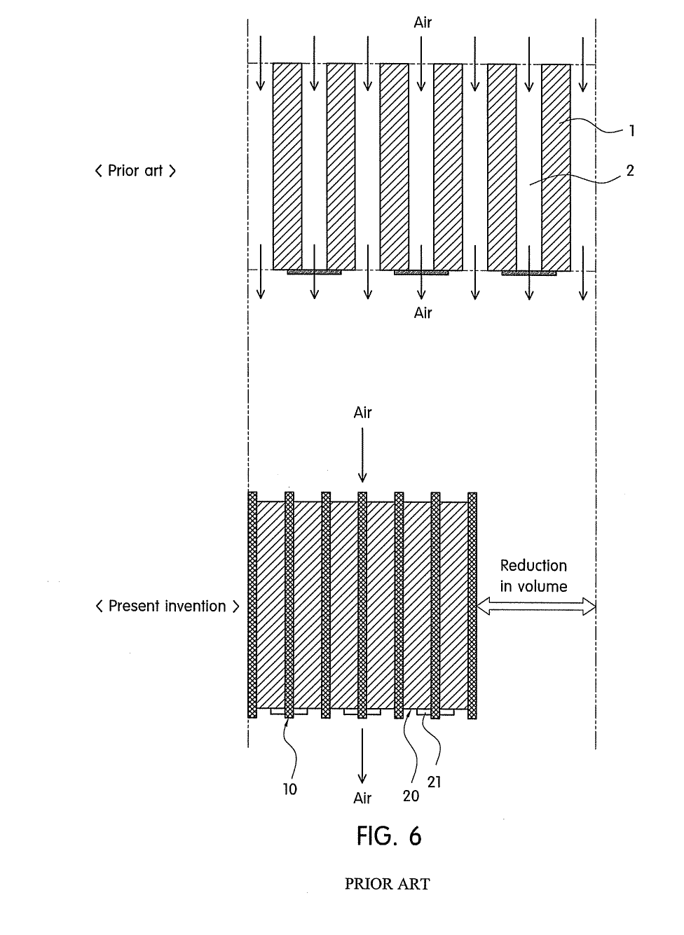

The metal foam plate 11 has a porous foam structure which provides elasticity to the heat dissipation plate 10 to respond to changes in volume of the battery cells. In other words, as shown in FIGS. 1 and 6, the heat dissipation plate 10 is interposed between battery cells 20 in a close contact manner, and when the battery cells 20 expand, the metal foam plate 11 of the heat dissipation plate 10 is compressed by the expansion of the battery cells 20 against the battery cells, thereby responding to changes in volume of the battery cells 20. Moreover, when the battery cells 20 contract, the metal foam plate 11 is restored to its original state and compresses the battery cells 20, thereby restoring them to their original states.

The sheet plate 13 is formed into a flat thin plate shape having a smooth surface. The heat dissipation plate 10 of the present invention has a structure in which the sheet plate 13 is stacked on both sides of the metal foam plate 11 such that the portion that comes into direct contact with the battery cell 20 has a smooth surface to maximize the contact area with the battery cell 20, which results in effective heat transfer by conduction. Moreover, the metal foam plate 11 inside the heat dissipation plate 10 has a porous foam structure to increase the specific surface area thereof, which also results in effective heat transfer and dissipation by convection.

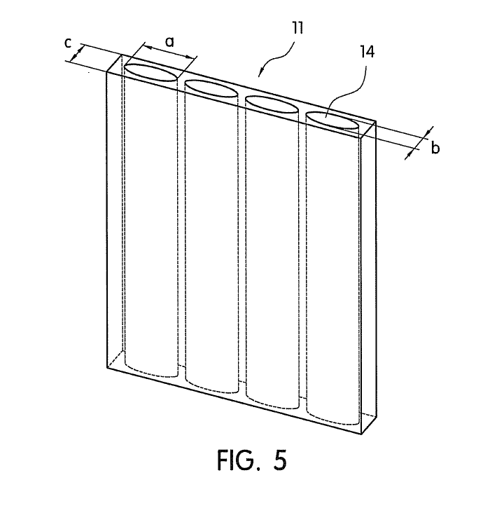

Moreover, as shown in FIG. 5, the heat dissipation plate 10 includes a unidirectional air channel 14 formed in the air flow direction passing through the battery module to provide the heat transfer and dissipation by convection. The air channel 14 is formed in the longitudinal direction of the metal foam plate 11 and, in particular, a plurality of air channels 14 are formed at regular intervals in the width direction of the metal foam plate 11.

The distance between adjacent air channels 14 may have a value obtained by dividing a value, obtained by subtracting a sum of the widths of all the air channels 14 formed in the width direction in the metal foam plate 11 from the width of the metal foam plate 11 in the width direction, by a value obtained by adding 1 to the number of all the air channels 14. That is, the distance between the air channels 14 may be determined as follows:

The distance between the air channels=(the width of the metal foam plate in the width direction−the sum of the widths of all the air channels formed in the metal foam plate)/(the number of all the air channels formed in the metal foam plate+1).

Preferably, the air channel 14 has an appropriate width such that the compression force applied to the heat dissipation plate 10 should not exceed a critical elastic stress of the metal foam plate 11 (or the heat dissipation plate 10). For example, aluminum 6061-T6 has a critical elastic stress of 250 Mpa. Moreover, the air channel 14 preferably has a value of 1 mm or higher, which is obtained by subtracting the height of the air channel 14 from the entire thickness of the metal foam plate 11. Furthermore, the heat dissipation plate 10 is preferably formed by applying the heat dissipation paste 12 onto both sides of the metal foam plate 11 and stacking and pressing the sheet plate 13 on the heat dissipation paste 12, thereby providing a soft, smooth and continuous surface.

The heat dissipation paste 12 preferably comprises carbon, carbon nanotubes, or metal which has a high thermal conductivity. As such, the heat dissipation plate 10 of the present invention has a porous foam structure from a microscopic point of view and a plate-like structure having the air channel 14 in the air flow direction from a macroscopic point of view.

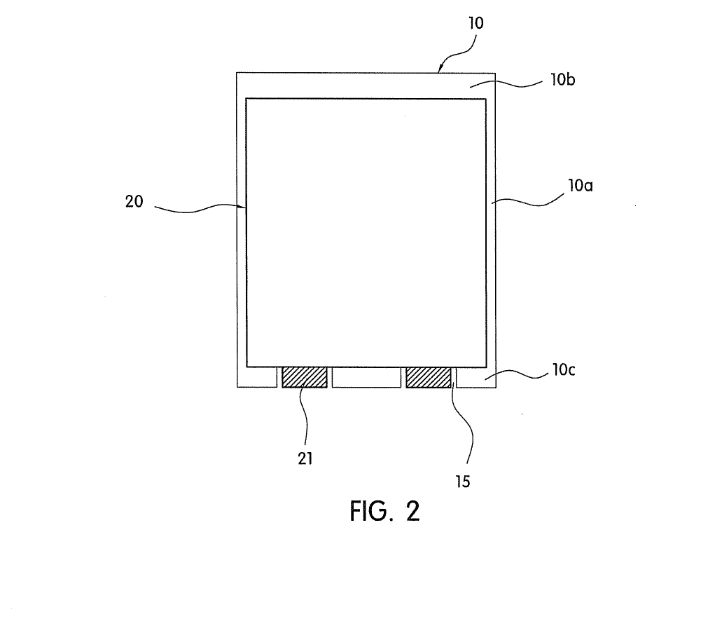

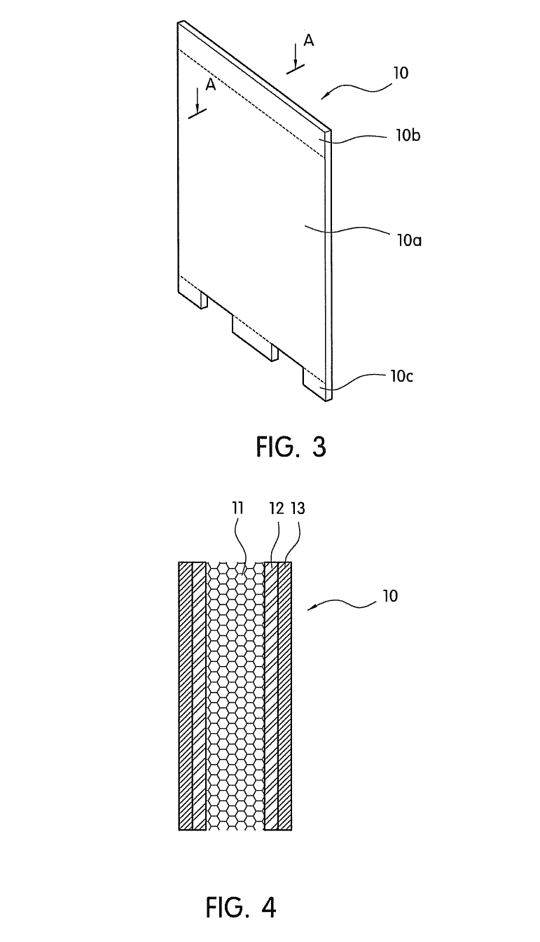

Referring to FIGS. 1 to 3, when the heat dissipation plate 10 is interposed between the battery cells 20, it is preferable that the heat dissipation plates 10 has upper and lower ends extending out further from the battery cell 20 than electrode portions 21. Accordingly, the heat dissipation plate 10 may be divided into a cell contact portion 10a, which comes into contact with the battery cells 20, and upper and lower projections 10b and 10c which project from both upper and lower ends of the cell contact portion 10a to the outside of the battery cells 20 and do not come into contact with the battery cells 20. Each of the upper and lower projections 10b and 10c may project about 10 mm from the battery cells 20, and the heat dissipation plate 10 having the upper and lower projections 10b and 10c may act as a cooling fin when the heat dissipation plate 10 is interposed between the battery cells 20.

Although not shown in the figures, the heat dissipation plate 10 of the present invention may have a structure in which the sheet plate 13 is omitted from the upper and lower projections 10b and 10c and the metal foam plate 11 is exposed. In detail, the heat dissipation plate 10 may be configured such that the sheet plate 13 stacked on both sides of the metal foam plate 11 is formed to have a size corresponding to the area of the cell contact portion 10a to be stacked only on the cell contact portion 10a. As a result, the upper and lower projections 10b and 10c that come into contact with the battery cells 20 include only the metal foam plate 11. Moreover, the metal foam plate 11 may be made of aluminum foam having a high thermal conductivity, and the sheet plate 13 may be a thin plate made of aluminum.

Reference numeral 15 denotes an electrode folding portion for folding each electrode portion 21 of the battery cell 20. Since the heat dissipation plate 10 is interposed between the battery cells 20, the electrode folding portion 15 for folding the electrode portion 21 of the battery cell 20 is provided so that adjacent electrode portions 21 of the battery cells 20 with the heat dissipation plate 10 interposed therebetween can be electrically connected together.

The above-described heat dissipation plate of the present invention may be manufactured as follows. The below example is manufactured utilizing aluminum, however, other materials which have a high conductivity may be used. The present invention is thus not limited to the example described below.

After melting 95.6 to 97.9 wt % aluminum at a temperature of 850 to 900° C., 1.5 to 3 wt % calcium is added to the molten aluminum while controlling the viscosity thereof. After reaching a viscosity for foaming, 0.6 to 1.4 wt % foaming agent is uniformly mixed with the resulting aluminum to create a foamy substance, thereby preparing an aluminum foam (i.e., metal foam plate). An air channel of 1 mm in diameter is formed in the metal foam plate with a thickness of 2 mm using a micro-adjustable drill.

In order to maximize the contact area with the battery cell, the metal foam plate having a smooth and continuous surface may be formed by applying a heat dissipation paste including carbon or metal and having a high thermal conductivity (100 W/mK or higher) onto both sides of the metal foam plate and then stacking and pressing an aluminum thin plate (i.e., sheet plate) having a thickness of 50 μm or less on the heat dissipation paste, and the thus formed metal foam plate having a cross-sectional structure shown in FIG. 4.

For reference, the battery cell is a pouch-type battery cell and is configured in such a manner that a positive electrode plate and a negative electrode plate are stacked on both sides of a separator interposed therebetween in a flexible case as well known in the art. Meanwhile, the battery module according to the present invention comprises the above-described heat dissipation plate 10 and is configured by modularizing a plurality of stacked battery cells 20 by a typical structure.

As well known in the art, the battery module is configured by connecting a plurality of battery cells 20 in series or in parallel, and the battery module according to the present invention comprises the above-described heat dissipation plate 10 interposed between the battery cells 20.

As shown in FIG. 1, the battery module according to the present invention has a structure in which the heat dissipation plate 10 including the metal foam plate 11 as a porous metal plate is interposed between the battery cells 20. Since the heat dissipation plate 10 is interposed between the battery cells 20, the heat dissipation plate 10 is used as an interface plate that improves the heat dissipation performance through air cooling of the battery module and flexibly responds to expansion and contraction during charging and discharging of the battery cells and the battery module.

In other words, with the use of the heat dissipation plate 10 having high elasticity and heat dissipation performance and acting as the interface plate interposed between the battery cells 20, when the battery cells 20 expand, the metal foam plate 11 of the heat dissipation plate 10 is compressed by the expansion of the battery cells 20 to elastically receive the expansion of the battery cells, thereby preventing damage of the battery cells 20 and the battery module.

Moreover, when the battery cells 20 contract, the metal foam plate 11 is restored to its original state and presses the battery cells 20 to be restored to their original states, thereby responding to changes in volume during the charge and discharge of the battery cells and the battery module.

The heat dissipation plate 10 has a structure in which the air channels 14 are formed in the metal foam plate 11, which is made of, e.g., aluminum or any other material having a high thermal conductivity and has a porous foam structure. The cell contact portion 10a that comes into direct contact with the battery cell 20 is formed to have a smooth flat plate shape by the heat dissipation past 12 and the sheet plate 13, thereby effectively dissipating the heat accumulated in the battery cells and the battery module through the air flow by the heat transfer by conduction and convection.

As shown in FIG. 6, an existing battery module has a structure in which a large air channel 2 for air flow between cells 1 is formed to respond to changes in volume of the battery cell 1 during charge and discharge and to dissipate heat accumulated inside the battery module to the outside. Compared to this, the battery module according to the present invention has a structure in which the heat dissipation plate 10 having high elasticity and heat dissipation performance is interposed between the battery cells 20 in a close contact manner. Thus, as shown in FIG. 6, the distance between the battery cells 20 is closed, compared to the existing battery module, to reduce the volume of the battery module and improve the heat dissipation characteristics, thereby improving the reliability of the battery module.

As described above, the heat dissipation plate for the battery cell according to the present invention is a porous metal plate that is interposed between the battery cells to flexibly respond to changes in volume of the battery cells and improve the heat dissipation performance due to increased specific surface area and air channels, thereby achieving a compact battery module with improved energy density with respect to the volume. Moreover, the battery module in which the heat dissipation plate according to the present invention interposed between the battery cells responds to changes in volume of the battery module and improves the heat dissipation performance, thereby improving lifespan and reliability of the battery module.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A heat dissipation plate for between a plurality of battery cells, the heat dissipation plate comprising:
a porous metal foam plate having a plate shape; and
a sheet plate stacked on both sides of the metal foam plate wherein the porous metal foam plate and the sheet plate are interposed between battery cells,
wherein when the battery cells expand, the metal foam plate is compressed by the expansion of the battery cells to respond to changes in volume of the battery cells and improve heat dissipation performance through air cooling due to increased specific surface area.

2. The heat dissipating plate of claim 1, further comprising a heat dissipation paste disposed on a surface of the metal foam plate and interposed between the metal foam plate and the sheet plate.

3. The heat dissipating plate of claim 1, wherein the metal foam plate comprises at least one unidirectional air channel for heat dissipation through air flow.

4. The heat dissipating plate of claim 1, wherein the metal foam plate and the sheet plate are made of aluminum.

5. The heat dissipating plate of claim 1, wherein the metal foam plate extends beyond a battery cell to upper and lower sides thereof, the metal foam plate projecting to an outside surface of the battery cells when interposed between the battery cells.

6. The heat dissipating plate of claim 1, wherein the metal foam plate comprises an electrode folding portion configured to fold an electrode portion, which is formed to penetrate a lower end of the metal foam plate.

7. A battery module comprising
a plurality of battery cells; and
a plurality of heat dissipation plates interposed between the battery cells,
wherein the heat dissipation plates include a porous metal foam plate formed by foaming and having a plate shape; and a sheet plate stacked on both sides of the metal foam plate,
wherein when the battery cells expand, the metal foam plate is compressed by the expansion of the battery cells and responds to changes in volume of the battery cells therefrom to improve heat dissipation performance by air cooling due to increased specific surface area.

8. The battery module of claim 7, wherein the heat dissipation plate further comprises a heat dissipation paste disposed on a surface of the metal foam plate and interposed between the metal foam plate and the sheet plate.

9. The battery module of claim 7, wherein the metal foam plate comprises at least one unidirectional air channel for heat dissipation by air flow.

10. The battery module of claim 7, wherein the metal foam plate and the sheet plate are made of aluminum.

11. The battery module of claim 7, wherein the metal foam plate extends from the battery cells to upper and lower sides of the battery cells to project to the outside of the battery cells.

12. The battery module of claim 7, wherein the metal foam plate comprises an electrode folding portion configured to fold an electrode portion, wherein the electrode portion is formed to penetrate a lower end of the metal foam plate.

13. A heat dissipation plate comprising:
a flexible porous plate formed in the shape of a plate having a foam-like consistency; and
a sheet plate stacked on both sides of the porous plate wherein the porous plate and the sheet plate are interposed between battery cells,
wherein when the battery cells expand, the porous plate is compressed by the expansion of the battery cells and responds to changes in volume of the battery cells and the porous plate dissipates heat from the battery cells therethrough through air cooling
wherein when the battery cells contract, the porous plate presses on the battery cells to return the battery cells to their original shape.
